(19) United States
(12) Patent Application Publication
(10) Pub. No.: US 2018/0070757 A1
(43) Pub. Date: Mar. 15, 2018

(54) COOKING APPARATUS AND CONTROL METHOD THEREOF

(71) Applicant: Samsung Electronics Co., Ltd., Suwon-si (KR)

(72) Inventors: Hyun Ju LEE, Suwon-si (KR); Han Seong Kang, Hwaseong-si (KR); Min Ho Yun, Suwon-si (KR); Yu Jeub Ha, Hwaseong-si (KR); Yeong Hyeok Kim, Seoul (KR); Duck Jin Sung, Suwon-si (KR); Pung Yeun Cho, Suwon-si (KR)

(73) Assignee: Samsung Electronics Co., Ltd., Suwon-si (KR)

(21) Appl. No.: 15/698,898

(22) Filed: Sep. 8, 2017

(30) Foreign Application Priority Data
Sep. 9, 2016 (KR) 10-2016-0116208

(51) Int. Cl. A47J 27/04; F24C 15/00; F24C 15/30; F24C 7/08; F24C 11/00; A23L 5/10; A47J 37/06

(52) U.S. Cl. CPC A47J 27/04; F24C 15/003; F24C 15/30; F24C 7/081; A47J 2027/043; A23L 5/13; A47J 37/0664; A23V 2002/00; F24C 11/00

(57) ABSTRACT

A cooking apparatus includes a first space where cooking is performed, a second space partitioned from the first space and having components configured to control an internal environment of the first space, a water supply device provided to supply steam to the first space, and a controller configured to control the water supply device to be inserted into or withdrawn from the second space.

### CROSS-REFERENCE TO RELATED APPLICATIONS

This application claims the benefit of Korean Patent Application No. 10-2016-0116208, filed on Sep. 9, 2016 in the Korean Intellectual Property Office, the disclosure of which is incorporated herein by reference.

### BACKGROUND

### 1. Field

Embodiments of the present disclosure relate to a cooking apparatus, and more particularly, to a cooking apparatus having an improved water supply device.

### 2. Description of the Related Art

Cooking apparatuses are appliances configured to cook food. There are various types of cooking apparatuses, and an oven is one example.

Generally, an oven is an appliance for cooking food by including a cooking compartment, a heater configured to apply heat to the cooking compartment, and a circulator configured to circulate heat generated by the heating device inside the cooking compartment.

An oven is an appliance for cooking an object to be cooked by sealing and heating the object to be cooked and can be classified as an electric type, a gas type, and an electronic type in accordance with a heat source thereof. An electric oven uses an electric heater as a heat source, and a gas oven and a microwave respectively use heat generated by gas and frictional heat of water molecules generated by high frequency as heat sources.

Recently, cooking apparatuses having a roasting function, a steam function, and the like have been developed to allow a user to cook various dishes. A cooking apparatus including a steam generator has been developed to allow indirectly cooking by steam heat by providing steam to an inside of a cooking compartment while food is being cooked to improve texture of food and decrease loss of nutrients contained in food.

### SUMMARY

Therefore, it is an aspect of the present disclosure to provide a cooking apparatus including a water supply device having an improved structure to be capable of automatically supplying water.

It is another aspect of the present disclosure to provide a cooking apparatus capable of improving cooking efficiency by securing a space of a cavity for cooking.

It is still another aspect of the present disclosure to provide a cooking apparatus capable of securing convenience and safety by preventing an accident in which water in a water reservoir is spilled due to exposure of a water supply device just by a control operation.

Additional aspects of the disclosure will be set forth in part in the description which follows and, in part, will be obvious from the description, or may be learned by practice of the disclosure.

In accordance with one aspect of the present disclosure, a cooking apparatus includes a first space where cooking is performed, a second space partitioned from the first space and having components configured to control an internal environment of the first space, a water supply device provided to supply steam to the first space, and a controller configured to control the water supply device to be inserted into or withdrawn from the second space.

The water supply device may include a water storage configured to accommodate water supplied externally, and a driver configured to move the water storage, wherein the controller may control the driver to control the water storage to be inserted into and withdrawn from the second space.

The water supply device may include one or more switches configured to detect movement of the water storage, and the controller may control the driver on the basis of output detected by the switches.

The cooking apparatus may further include a control panel configured to receive one or more input commands from a user.

The controller may control insertion or withdrawal of the water supply device on the basis of the one or more input commands transmitted from the control panel.

In accordance with another aspect of the present disclosure, a cooking apparatus includes a first space where cooking is performed, a second space partitioned from the first space and having components configured to control an internal environment of the first space, and a water supply device provided to supply steam to the first space, wherein the water supply device is provided to be insertable into or withdrawable from the second space.

The second space may be disposed above the first space.

The cooking apparatus may further include a door configured to open or close the first space.

When the door closes the first space, the water supply device may be covered by the door.

When the door opens the first space, the water supply device may be exposed toward a front thereof by the door.

The water supply device may include a housing provided inside the second space, a water storage provided to be inserted into or withdrawn from the housing, and a driver configured to move the water storage.

The water storage may include a water reservoir having an inlet through which water is introduced, and a rubber cap detachably provided at the inlet of the water reservoir.

The driver may include a motor and a gear member configured to connect the motor and the water storage.

The water supply device may include a steam generator connected to the water storage.

The driver may further include a switch provided to limit withdrawal of the water reservoir.

The water supply device may include a pump configured to connect the water storage to the steam generator.

In accordance with still another aspect of the present disclosure, a control method of a cooking apparatus includes receiving one or more input commands from a user, and controlling, on the basis of the input commands, a water supply device inserted into or withdrawn from a second space that is partitioned from a first space where cooking is performed.

The water supply device may include a water storage configured to accommodate water supplied externally, and a driver configured to move the water storage.

The control method may further include detecting movement of the water storage.

The controlling may include controlling an operation of the driver on the basis of output detecting movement of the water storage.

The control method may further include outputting a result of insertion or withdrawal of the water supply device to the user.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating a cooking apparatus according to an embodiment of the present disclosure;

FIG. 2 is a perspective view illustrating the cooking apparatus according to the embodiment with a part thereof cut away;

FIGS. 3 and 4 are views illustrating states of a water supply device in accordance with a door operation of the present disclosure;

FIG. 5 is a rear perspective view illustrating the cooking apparatus according to the embodiment with the part thereof cut away;

FIG. 6 is an exploded perspective view illustrating a housing and a water storage of the water supply device according to the embodiment of the present disclosure;

FIG. 7 is a view illustrating movement of the water storage by a driver of the water supply device according to the embodiment of the present disclosure;

FIG. 8 is a control block diagram of the cooking apparatus according to a disclosed example;

FIG. 9 is a view for describing a configuration that is involved in an operation of the water supply device according to the example;

FIGS. 10A to 10C are views for describing an insertion or withdrawal operation of the water storage;

FIGS. 11A and 11B are views for describing an operation of a control panel;

FIG. 12 is a flowchart for describing a control method related to the withdrawal operation of the water storage; and

FIG. 13 is a flowchart for describing a control method related to the insertion operation of the water storage.

### DETAILED DESCRIPTION

Various embodiments described herein and configurations illustrated in the drawings are merely exemplary embodiments of the present disclosure, and various modifications which may replace the embodiments and the drawings herein may be present at the time of filing this application.

Like reference numerals or symbols presented in the drawings of the application indicate parts or elements that perform substantially the same functions.

Terms used herein are for describing the embodiments and are not intended to limit and/or restrict the disclosure. A singular expression includes a plural expression unless context clearly indicates otherwise. In the application, terms such as “include” or “have” should be understood as designating that features, number, steps, operations, elements, parts, or combinations thereof exist and not as precluding the existence of or the possibility of adding one or more other features, numbers, steps, operations, elements, parts, or combinations thereof in advance.

Terms including ordinals such as “first” and “second” may be used to describe various elements, but the elements are not limited by the terms. The terms are only used for the purpose of distinguishing one element from another element. For example, a second element may be referred to as a first element while not departing from the scope of the present disclosure, and likewise, a first element may also be referred to as a second element. The term “and/or” includes a combination of a plurality of related described items or any one item among the plurality of related described items.

Hereinafter, embodiments according to the present disclosure will be described in detail with reference to the accompanying drawings.

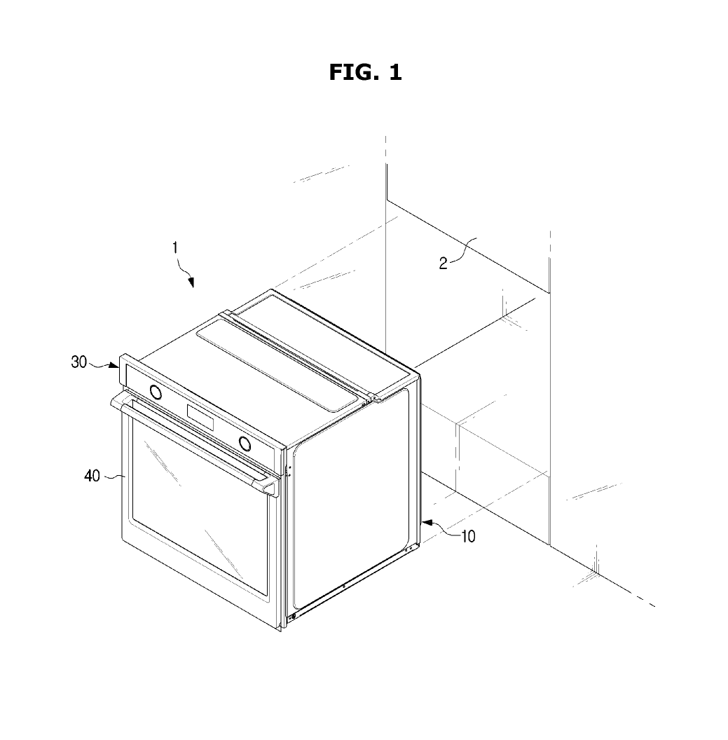

“Front surface” and “front” used hereinafter respectively refer to a front surface visible from in front of a cooking apparatus 1 illustrated in FIG. 1 and a direction toward the front of the cooking apparatus 1, and “rear” refers to a direction toward the rear of the cooking apparatus 1. Although the cooking apparatus according to an embodiment of the present disclosure is described as a built-in that is installed in a cabinet, the idea of the present disclosure is not limited thereto.

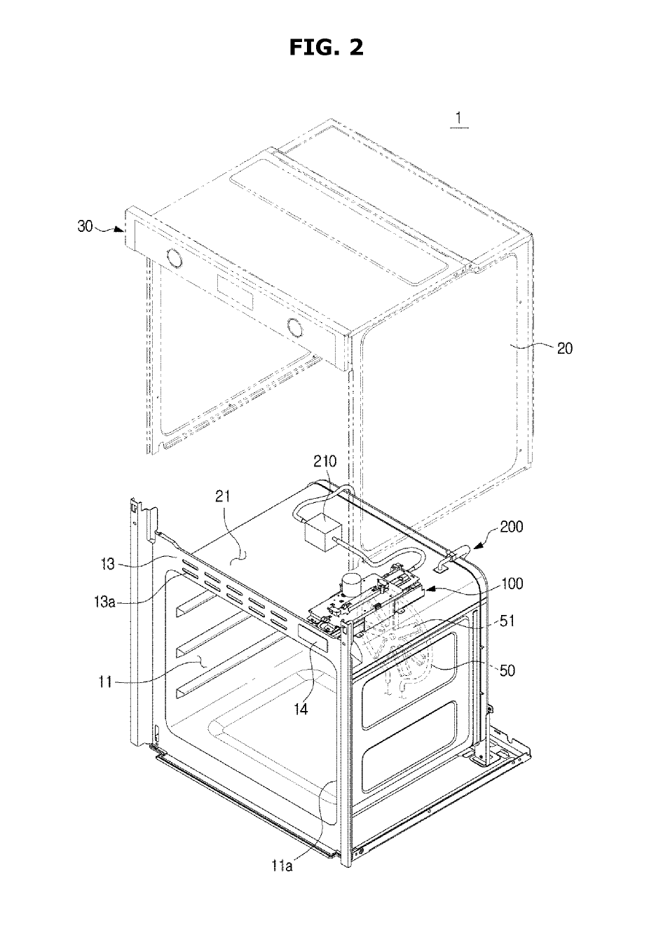

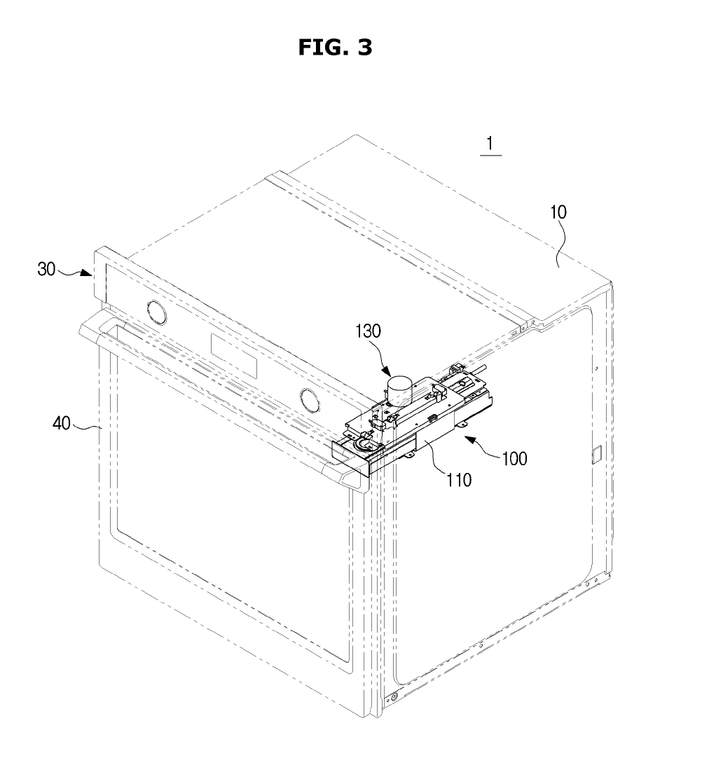

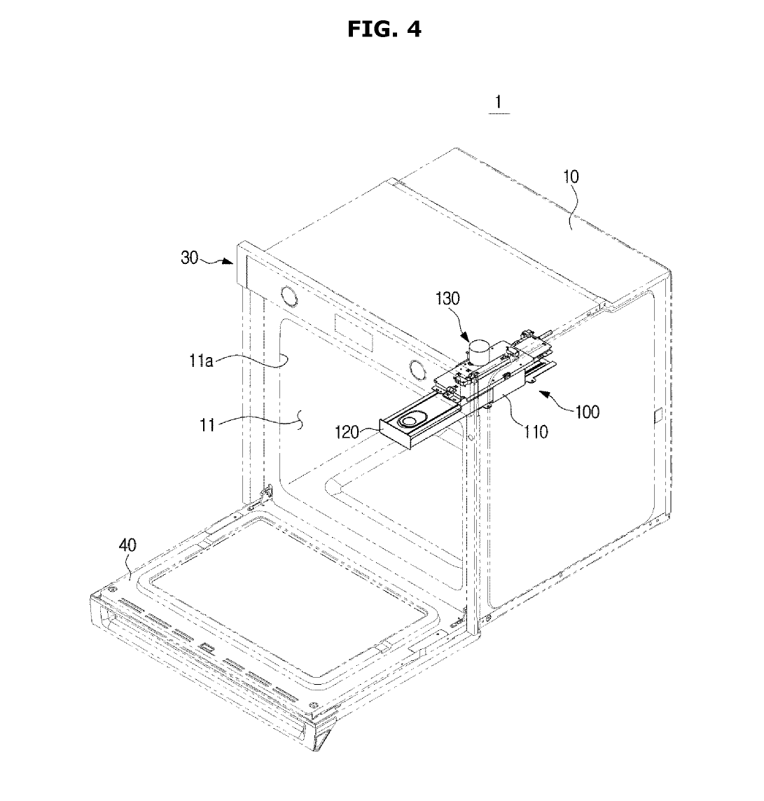

FIG. 1 is a perspective view illustrating a cooking apparatus according to an embodiment of the present disclosure, FIG. 2 is a perspective view illustrating the cooking apparatus according to the embodiment with a part thereof cut away, and FIGS. 3 and 4 are views illustrating states of a water supply device in accordance with a door operation of the present disclosure.

As illustrated in FIGS. 1 to 4, the cooking apparatus 1 may be installed inside a wall or a cabinet 2 to have a sense of unity with a kitchen space. The cabinet 2 for installing the cooking apparatus 1 may have, for example, a partially open front surface, and the cooking apparatus 1 may be accommodated via the open portion.

The cooking apparatus 1 may include a main body 10, a first space (hereinafter, a cooking compartment 11) formed so that cooking is performed therein, and a second space (hereinafter, a machine room 21) formed at an outside of the main body 10 to have various electronic components installed therein.

The main body 10 may further include a case 20 forming an exterior thereof. The case 20 may be provided so that a space is formed between the main body 10 and the case 20 at the outside of the main body 10.

A control panel 30 including various buttons (not illustrated) for a user to control an operation of the cooking apparatus 1 may be installed in front of the case 20.

A convection heater 50 and a convection fan 51 provided to heat the cooking compartment 11 may be installed at one or more of an upper portion, both side portions, and a rear portion of the main body 10. The main body 10 may include a steam generator 200 configured to generate steam and supply steam to an inside of the cooking compartment 11.

The convection heater 50 may provide heat for heating food inside the cooking compartment 11, and the convection fan 51 may allow convection of heat generated by the convection heater 50 inside the cooking compartment 11 or allow steam generated by the steam generator 200, separate from the convection heater 50, to evenly circulate throughout the inside of the cooking compartment 11. The steam generator 200 is provided in the main body 10. The steam generator 200 may be connected to a water supply device 100 for supplying water to the steam generator 200. The water supply device 100 is provided to supply steam to the cooking compartment 11 of the main body 10. The water supply device 100 may be provided at an upper side of the main body 10.

The machine room 21 in which components configured to control the internal environment of the cooking compartment 11 are provided is provided at the upper side of the main body 10. The control panel 30 for enabling the user to control an operation of the cooking apparatus 1 may be disposed at an upper front portion of the main body 10.

The water supply device 100 may be provided in the machine room 21 of the main body 10. The water supply device 100 may be provided at an upper front side of the machine room 21. The water supply device 100 may be movably provided to be inserted into or withdrawn from the machine room 21 in a front-rear direction.

The main body 10 may have a rectangular parallelepiped shape with an opening 11a in the front thereof, and food for cooking may enter or exit the main body 10 via the opening 11a in the front thereof. The cooking compartment 11 in which food is placed may be opened or closed by a door 40 coupled to the front of the main body 10. The door 40 may selectively open or close the cooking compartment 11.

The door 40 has a size corresponding to that of the front surface of the main body 10. The door 40 may be pivotally coupled to a lower end of the front surface of the main body 10 to open or close the cooking compartment 11. Although an example in which the door 40 is provided to be rotatable by a hinge device (not illustrated) at the lower end of the main body 10 is illustrated, the idea of the present disclosure is not limited thereto. For example, the door may be hinged or coupled to the main body in various other ways.

The front surface of the main body 10 includes the opening 11a of the cooking compartment 11. A front surface frame 13 may be formed above the opening 11a. The front surface frame 13 is formed at an outer side of the cooking compartment 11. The front surface frame 13 may include at least a portion of the machine room 21. One or more holes 13a may be formed in the front surface frame 13. The holes 13a are formed so that outside air may flow into the machine room 21 of the cooking apparatus 1. Although an example in which the front surface frame 13 is formed above the opening 11a is illustrated as an example in the embodiment of the present disclosure, the idea of the present disclosure is not limited thereto. For example, the front surface frame may also be formed at a lower portion or a side surface of the opening.

A water supply device installation hole 14 for installing the water supply device 100 may be formed in the front surface frame 13. The water supply device installation hole 14 may be formed at one end of the front surface frame 13. The water supply device 100 may be disposed behind the water supply device installation hole 14, i.e., inside the machine room 21, to be withdrawn from and inserted into the front surface frame 13.

The door 40 may be formed with a size and shape corresponding to those of the front surface of the main body 10. The door 40 may be formed to open or close the cooking compartment 11. The door 40 may be formed to open or close the opening 11a of the main body 10. The door 40 may be formed with a size and shape corresponding to a size and shape including the front surface frame 13 to cover the front surface frame 13 of the main body 10.

When the door 40 is opened, the door 40 pivots about the lower end of the main body 10, and an upper end of the door 40 moves toward a lower front side and opens the cooking compartment 11. When the door 40 is opened, the water supply device 100 disposed at an upper front side of the main body 10 may be exposed toward a front thereof. When the door 40 is in an open state, the water supply device 100 may be exposed outside the main body 10. The water supply device 100 is movably provided to be withdrawn forward or inserted inward when the door 40 is open so that the user can supply water to the water supply device 100.

When the door 40 is closed, the door 40 pivots about the lower end of the main body 10, and the upper end of the door 40 moves toward an upper front side and closes the cooking compartment 11. When the door 40 is closed, the water supply device 100 may be inserted into the main body 10 and covered by the door 40. When the door 40 is closed, the water supply device 100 may be concealed by the door 40 so as not to be exposed from an outside of the cooking apparatus 1.

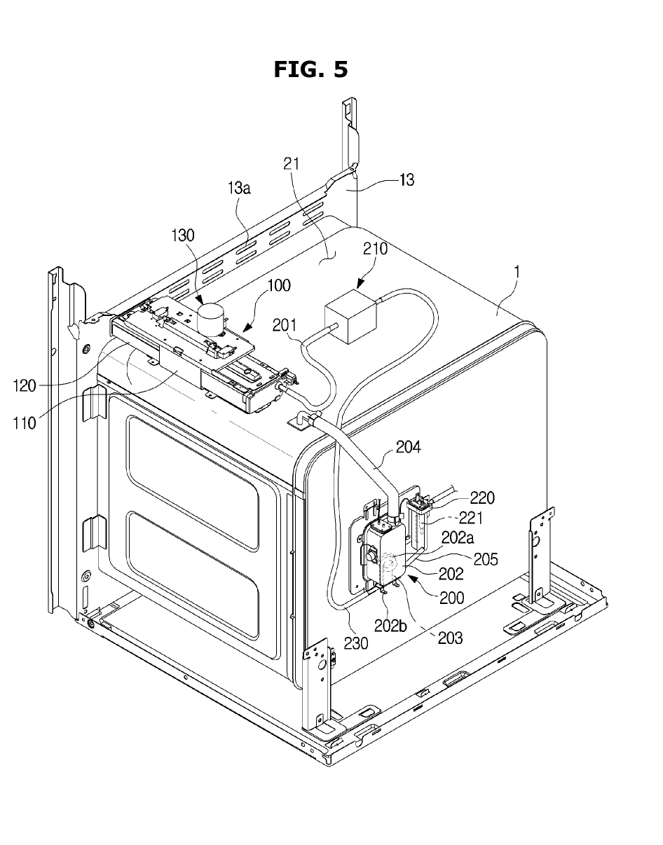

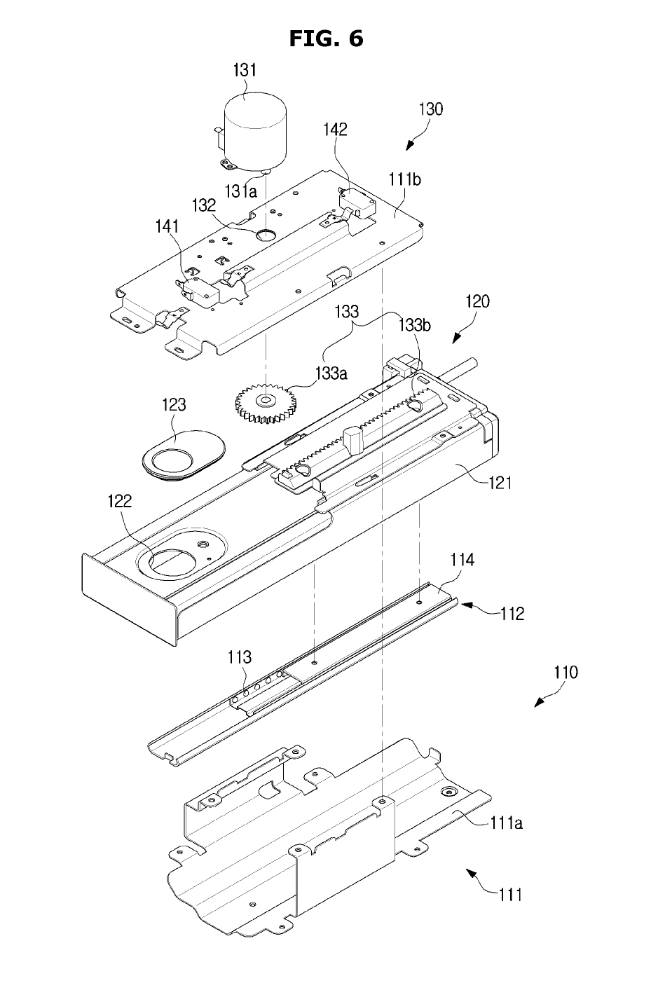

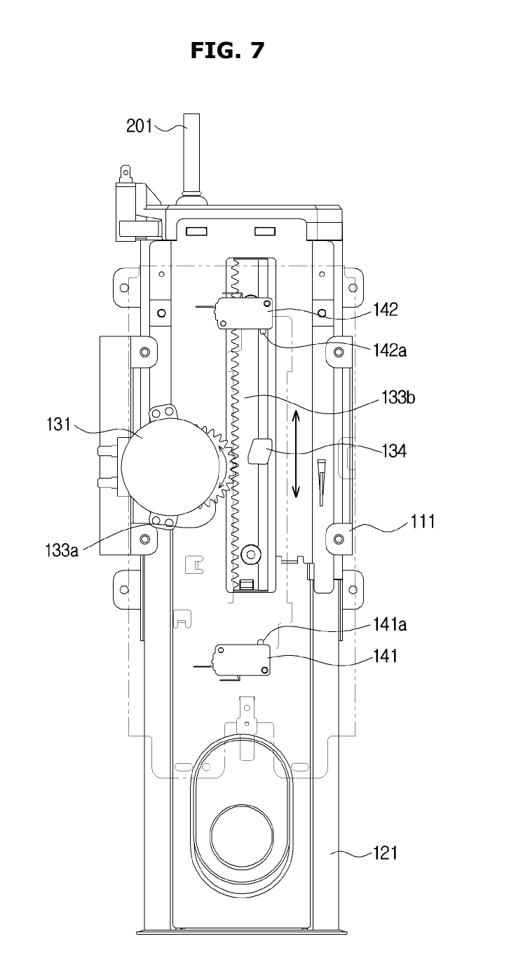

FIG. 5 is a rear perspective view illustrating the cooking apparatus according to the embodiment with the part thereof cut away, FIG. 6 is an exploded perspective view illustrating a housing and a water storage of the water supply device according to the embodiment of the present disclosure, and FIG. 7 is a view illustrating movement of the water storage by a driver of the water supply device according to the embodiment of the present disclosure.

As illustrated in FIGS. 5 to 7, the water supply device 100 may be connected to the steam generator 200. The steam generator 200 may be disposed at a rear surface of the main body 10.

The steam generator 200 is provided to heat water supplied via the water supply device 100, generate steam, and supply the generated steam to the inside of the cooking compartment 11. The steam generator 200 may include an auxiliary steam generator 220. The auxiliary steam generator 220 may include a water level measurement sensor 221 configured to measure the water level of water stored in the steam generator 200.

The water supply device 100 may be connected to the steam generator 200 via a pump 210. The water supply device 100 is connected to the pump 210 via a first connecting tube 201. Water of the water supply device 100 is delivered to the steam generator 200 via the first connecting tube 201.

The steam generator 200 may include a steam container 202 configured to store water introduced from the water supply device 100, a heating heater 203 configured to heat water stored in the steam container 202, and a steam supply tube 204 configured to guide steam heated and generated by the heating heater 203 toward the inside of the cooking compartment 11. The steam supply tube 204 may be connected to the upper side of the main body 10.

The heating heater 203 provided inside the steam container 202 includes a heater 202a formed to be wound in a substantially coil-like shape, and electrodes 202b formed by the heater 202a extending outside the steam container 202. The electrodes 202b may be connected to an external power supply (not illustrated) and allow a current to flow in the heater 202a so that a temperature of the heater 202a may increase.

The steam generator 200 and the auxiliary steam generator 220 may be connected via a second connecting tube 205. The second connecting tube 205 may allow water introduced into the steam generator 200 to be simultaneously introduced into the auxiliary steam generator 220.

The water supply device 100 may be connected to the pump 210. The pump 210 may be disposed at the upper side of the main body 10. The pump 210 may be disposed in the vicinity of the water supply device 100. The pump 210 may be disposed at one side of the machine room 21. The pump 210 may be connected to the steam container 202 of the steam generator 200.

The water supply device 100 may include a housing 110 fixed to the machine room 21 of the main body 10, and a water storage 120 movably provided to be inserted into and withdrawn from the housing 110.

The housing 110 of the water supply device 100 may be provided at one front side of the machine room 21. The housing 110 may be disposed in front of the machine room 21. The housing 110 may be fixed to one front side of the machine room.

The water storage 120 is provided to accommodate water supplied externally. The water storage 120 may be connected to the pump 210 via the first connecting tube 201 to be connected to the steam generator 200 and may be connected to the steam container 202 of the steam generator 200 via a third connecting tube 230.

The third connecting tube 230 may connect the pump 210 and the steam generator 200. The third connecting tube 230 may be provided to supply water of the water supply device 100, which is supplied to the pump 210, to the steam generator 200.

Although an example in which the water supply device 100 and the steam generator 200 are connected via the pump 210, the first connecting tube 201, and the third connecting tube 230 is illustrated in the embodiment of the present disclosure, the idea of the present disclosure is not limited thereto. For example, water may be movable due to a weight thereof from the water supply device 100 disposed above the steam generator 200.

The housing 110 may include fixing brackets 111 and a rail 112 provided to make the water storage 120 movable. The fixing brackets 111 may include a first fixing bracket 111a provided to be fixed to an upper surface of the main body 10, and a second fixing bracket 111b provided to be fixed to the first fixing bracket 111a.

The water storage 120 and the rail 112 provided to make the water storage 120 movable may be provided on the first fixing bracket 111a. The rail 112 may include a ball bearing 113 and a movable bracket 114 provided to be movable in a front-rear direction of the rail 112 by the ball bearing 113. The water storage 120 may be installed at the movable bracket 114.

The water storage 120 includes a water reservoir 121 provided to be withdrawable toward the front of the main body 10. The water reservoir 121 is formed so that water may be stored therein. An inlet 122 through which water is introduced may be formed in an upper surface of the water reservoir 121. The inlet 122 may be formed in a front portion of the upper surface of the water reservoir 121. The water reservoir 121 is fixed to the movable bracket 114 of the rail 112 and is provided to be slidable in a front-rear direction of the main body 10 by movement of the movable bracket 114.

A rubber cap 123 may be detachably provided at the inlet 122 of the water reservoir 121. The rubber cap 123 may be formed with a rubber material. The rubber cap 123 may be formed in a shape corresponding to that of the inlet 122. The rubber cap 123 may be provided to seal the water reservoir 121. The user may remove the rubber cap 123 of the water reservoir 121 withdrawn toward the front of the main body 10 to supplement water in the water reservoir 121 and supply water via the inlet 122.

A driver 130 provided to automatically move the water reservoir 121 back and forth may be provided above the water reservoir 121. The driver 130 may be provided at the second fixing bracket 111b.

The driver 130 may include a motor 131 and a gear member 133 configured to connect the motor 131 and the water storage 120 to each other. The motor 131 may be installed via a motor installation hole 132 of the second fixing bracket 111b.

The gear member 133 may include a first gear unit 133a rotating due to rotation of the motor 131 and a second gear unit 133b provided to linearly move due to rotation of the first gear unit 133a. The first gear unit 133a may be formed in a cylindrical shape. The first gear unit may include a pinion gear. The second gear unit 133b may include a rack gear corresponding to the first gear unit 133a. The second gear unit 133b may be fixed to the upper surface of the water reservoir 121 of the water storage 120.

When the motor 131 rotates, the first gear unit 133a connected to a motor shaft 131a rotates. The second gear unit 133b engaged with the gear of the first gear unit 133a moves due to rotation of the first gear unit 133a. The water reservoir 121 to which the second gear unit 133b is fixed moves together with movement of the second gear unit 133b.

Here, the first connecting tube 201 connected to a rear end of the water reservoir 121 may be formed with a rubber or synthetic resin material so that the first connecting tube 201 may be easily bent to be movable frequently in a process in which the water reservoir 121 is withdrawn and inserted in the front-rear direction of the main body 10 and is not deformed due to movement.

The second fixing bracket 111b may further include switches 140 configured to detect back and forth movement of the water reservoir 121. The water reservoir 121 is not completely withdrawn toward the front of the main body 10 and protrudes forward only to an extent in which the inlet 122 of the water reservoir 121 may be exposed. The second fixing bracket 111b may further include the switches 140 operated by the second gear unit 133b to detect movement of the water reservoir 121.

The switches 140 may include a first switch 141 and a second switch 142. The first switch 141 may be disposed to detect movement of one end of the second gear unit 133b, and the second switch 142 may be disposed to detect movement of the other end of the second gear unit 133b. Consequently, movement of the second gear unit 133b toward one side, the other side, a front side and a rear side may be detected, the motor 131 may be controlled in accordance with the detection, and the water reservoir 121 may be movably provided.

The first switch 141 includes a first detector 141a configured to detect a force of an end of the second gear unit 133b. The second switch 142 includes a second detector 142a pressed by the force of the end of the second gear unit 133b.

That is, the switches 140 detect movement of the ends by pressures transmitted to the detectors 141a and 142a and thus assists in controlling a back and forth movement operation of the water reservoir 121.

Hereinafter, a control method of operating the water supply device 100 by the cooking appliance 1 disclosed herein will be described.

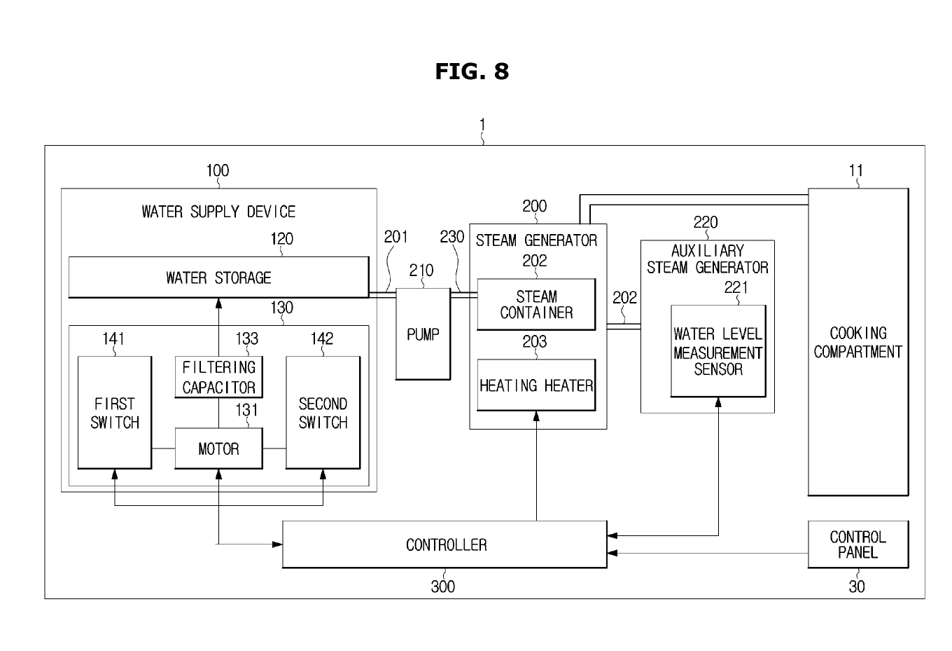

FIG. 8 is a control block diagram of the cooking apparatus according to a disclosed example.

Referring to FIG. 8, the cooking apparatus 1 according to the disclosed example may include the water supply device 100 configured to supply water required to generate steam, the pump 210 configured to deliver water of the water supply device 100, the steam generator 200 configured to generate steam using water delivered by the pump 210, the auxiliary steam generator 220 configured to assist the steam generator 200, the cooking compartment 11 to which the generated steam is ejected, a controller 300 configured to control each element of the cooking apparatus 1 disclosed herein, and the control panel 30 configured to connect the controller 300 to the user.

Of the elements illustrated in FIG. 8, descriptions of elements overlapping those described above with reference to FIGS. 1 to 7 will be omitted.

The controller 300 is a processor configured to collectively control the elements of the cooking apparatus 1.

The controller 300 may be implemented by a memory (not illustrated) configured to store data related to an algorithm for controlling operations of the elements in the cooking apparatus 1 or a program implemented using the algorithm, and a processor (not illustrated) configured to execute the above-described operations using the data stored in the memory. Here, the memory and the processor may be implemented with separate chips. Alternatively, the memory and the processor may be implemented with a single chip.

The controller 300 controls the motor 131 of the water supply device 100 on the basis of a signal transmitted by the control panel 30.

Specifically, when the user inputs an operational command to the control panel 30 to supply water to the water storage 120, the control panel 30 transmits the operational command to the controller 300.

The controller 300 transmits a control signal so that the motor 131 rotates on the basis of the operational command.

The motor 131 rotates due to the control signal generated from the controller 300, and the first gear unit 133a connected to the motor shaft 131a rotates. The second gear unit 133b engaged with the gear of the first gear unit 133a moves due to rotation of the first gear unit 133a. The water storage 120 to which the second gear unit 133b is fixed moves together with movement of the second gear unit 133b.

Here, a filtering capacitor 133 illustrated in FIG. 8 is an element that serves as a buffer that smoothens movement of the water storage 120 moving together with the gear member 133.

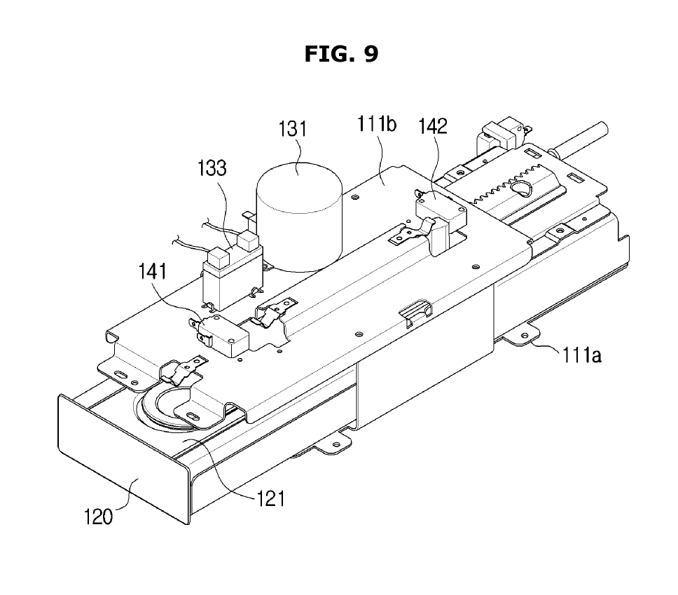

Specifically, the filtering capacitor 133 maintains a voltage so that a large amount of current supplied from a power supply is prevented from being supplied to a circuit. That is, the filtering capacitor 133 is a capacitor that smoothens ripple in the circuit. Elements related to the filtering capacitor 133 will be described again with respect to FIG. 9.

The controller 300 receives a signal transmitted by the switches 140 configured to detect movement of the water storage 120 and determines whether a movement operation of the water storage 120 is completed.

By way of example, when the water storage 120 moves by a predetermined distance toward the front of the cooking apparatus 1, one end of the water storage 120 comes into contact with the first detector 141a of the first switch 141. The first switch 141 generates an electrical signal by the operation of the first detector 141a and transmits the generated electrical signal to the controller 300.

In another example, water is supplied to the water storage 120, and the user inputs an insertion command to the control panel 30. The controller 300 controls the motor 131 to rotate in a reverse direction. When the water storage 120 moves by a predetermined distance toward the rear of the cooking apparatus 1, one end of the water storage 120 comes into contact with the second detector 142a of the second switch 142. The second switch 142 generates an electrical signal by the operation of the second detector 142a, and the controller 300 determines, on the basis of the signal from the second switch 142, that movement of the water storage 120 is completed.

When the controller 300 determines that supplying water is completed, the controller 300 controls the heating heater 203, generates steam using supplied water, and stores the steam in the steam container 202.

The controller 300 may measure a water level of water stored in the steam generator 200 on the basis of a result of detection by the water level measurement sensor 221 of the auxiliary steam generator 220.

When supply of water is required as a result of the measurement, the controller 300 may warn the user via the control panel 30 or output a signal indicating that supply of water is required.

As mentioned above, the control panel 30 receives an input command from the user and transmits the received input command to the controller 300.

Particularly, when the user touches a “reservoir” button 31a among operational buttons 31 disposed on the control panel 30, the controller 300 operates the water supply device 100 including the motor 131 and causes the water reservoir 121 to be inserted into or withdrawn from the cooking apparatus 1.

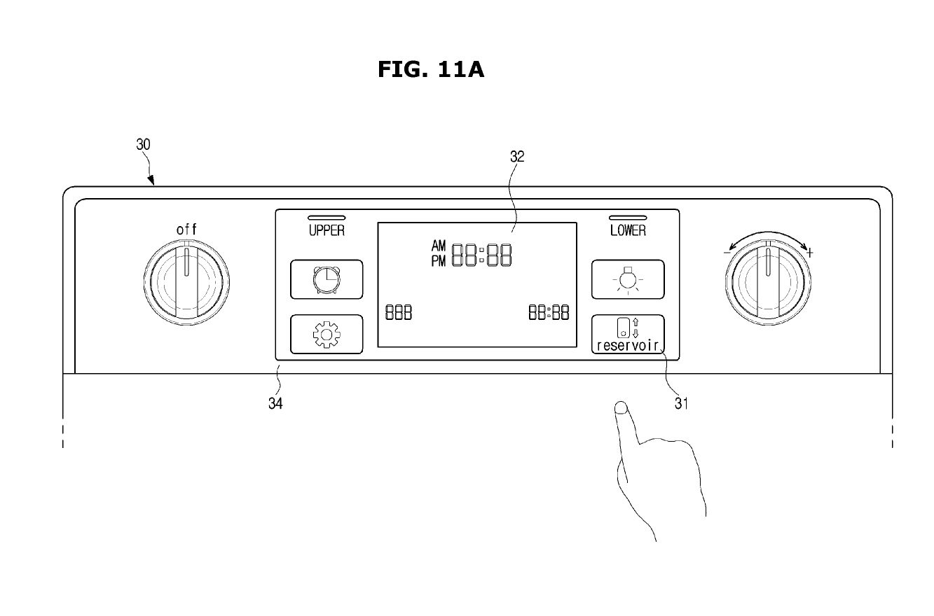

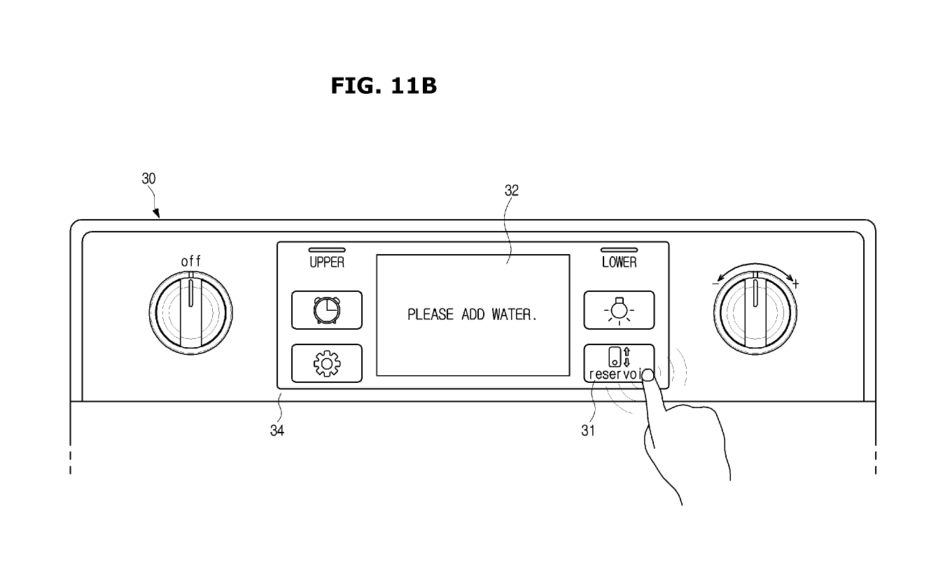

A configuration of the control panel according to the example will be described below with reference to FIGS. 11A and 11B.

FIG. 9 is a view for describing a configuration that is involved in an operation of the water supply device according to the example.

As described above, in the water supply device 100, the water storage 120 including the water reservoir 121 is inserted into or withdrawn from the front surface of the main body 10 by control of the controller 300.

Here, the water storage 120 is disposed at an upper surface of the first fixing bracket 111a including the rail 112 and the like provided to make the water storage 120 movable. The second fixing bracket 111b is located at an upper surface of the water storage 120, is provided inside the machine room 21, and has a shape surrounding the water storage 120 together with the first fixing bracket 111a.

The second fixing bracket 111b may include the motor 131 installed via the motor installation hole 132 and the switches 140 configured to detect movement of the water storage 120 and may further include the filtering capacitor 133.

The motor 131 refers to a device configured to convert electrical energy into mechanical energy. The motor 131 according to the disclosed example may be a DC motor that performs linear movement and rotation with respect to a change in an input voltage that is input from a power supply in accordance with control of the controller 300.

When an input command related to withdrawal of the water storage 120 from the user is applied to the motor 131, the motor 131 rotates in a predetermined direction in accordance with an instruction from the controller 300 and transmits torque generated by the rotation to the first gear unit 133a.

The torque, i.e., a rotational force, is converted into linear motion of the second gear unit 133b by the first gear unit 133a, and the second gear unit 133b causes the water storage 120 to be withdrawn toward the front surface of the main body 10 from an upper portion of the main body 10 along the rail provided at the first fixing bracket 111a.

In accordance with an input command related to insertion of the water storage 120 from the user, the motor 131 rotates in an opposite direction of rotation due to the withdrawal command.

When the motor 131 rotates in the opposite direction, the water storage 120 is inserted toward a lower surface of the main body 10 due to the first gear unit 133a and the second gear unit 133b.

According to the example, one or more of the switches 140 may be provided at the second fixing bracket 111b. In the cooking apparatus 1 disclosed herein, the switches 140 may be micro-switches.

Specifically, the plurality of switches 141 and 142 detect a moving distance by which the water storage 120 linearly moves along the rail 112.

When the water storage 120 is withdrawn by a predetermined distance, the first switch 141 may detect the withdrawal of the water storage 120. When the water storage 120 is inserted by a predetermined distance, the second switch 142 may detect the insertion of the water storage 120. According to an example, the predetermined distance may be 150 mm.

According to the example, the first switch 141 detects a pressure that the water storage 120 applies in accordance with the linear motion generated by the second gear unit 133b. In the first switch 141, the pressure is detected by the first detector 141a protruding toward a lower surface of the cooking apparatus 1.

Specifically, when a protrusion 134 provided in the water storage 120 moves and applies pressure to the first detector 141a, the first switch 141 outputs a signal to the controller 300.

The second detector 142a of the second switch 142 also detects a pressure that the protrusion 134 applies due to the insertion operation of the water storage 120. That is, when the second detector 142a also detects the pressure applied due to movement of the protrusion 134, the second switch 142 outputs a signal to the controller 300. The controller 300 may determine, on the basis of the signals transmitted from the switches 140, that movement of the water storage 120 is completed and stop the operation of the motor 131.

The switches 140 may perform detection using various methods, and the methods are not limited.

The filtering capacitor 133 smoothens movement of the water storage 120 that moves by rotation of the motor 131.

Specifically, the filtering capacitor 133 may be fixed to the second fixing bracket 111b. The filtering capacitor 133 and the motor 131 may be connected via a wire over an upper surface of the second fixing bracket 111b.

After the motor 131 receives power and operates, the operation may suddenly stop due to a result of detection by the switches 140. In this case, the water storage 120 may stop moving with a great reaction. In this case, supplied water may run over the water storage 120 and enter the machine room 21.

The filtering capacitor 133 stores power to prepare for sudden interruption to the power supply, and, even when the power supply is interrupted, the filtering capacitor 133 supplies power to the motor 131 for a predetermined amount of time. The motor 131 operates for the predetermined amount of time by power supplied by the filtering capacitor 133, and thus serves to smoothen movement of the water storage 120.

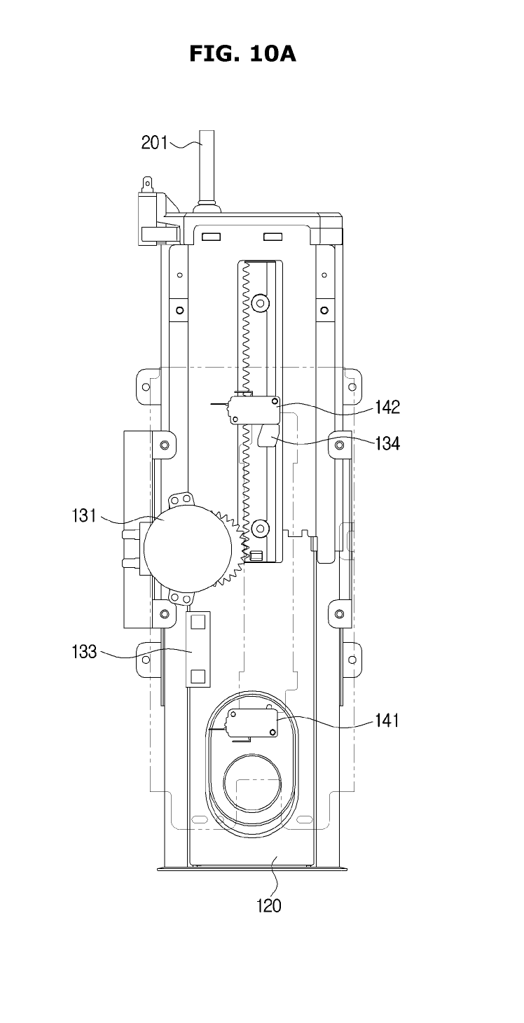

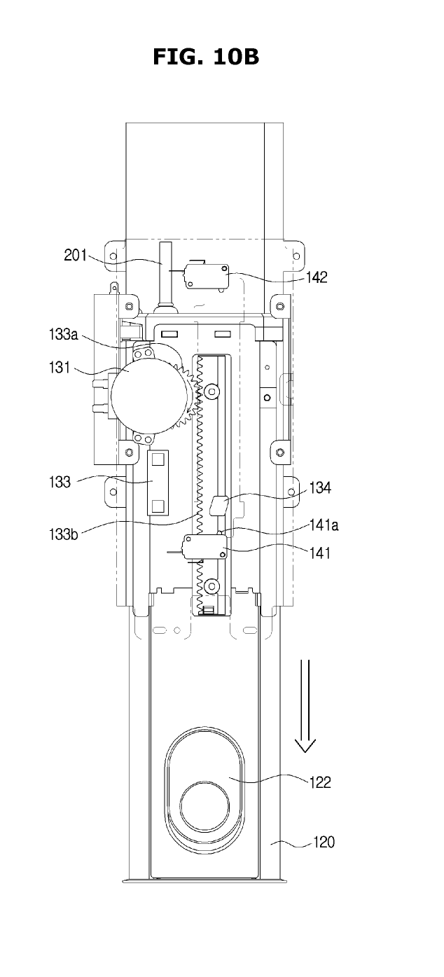

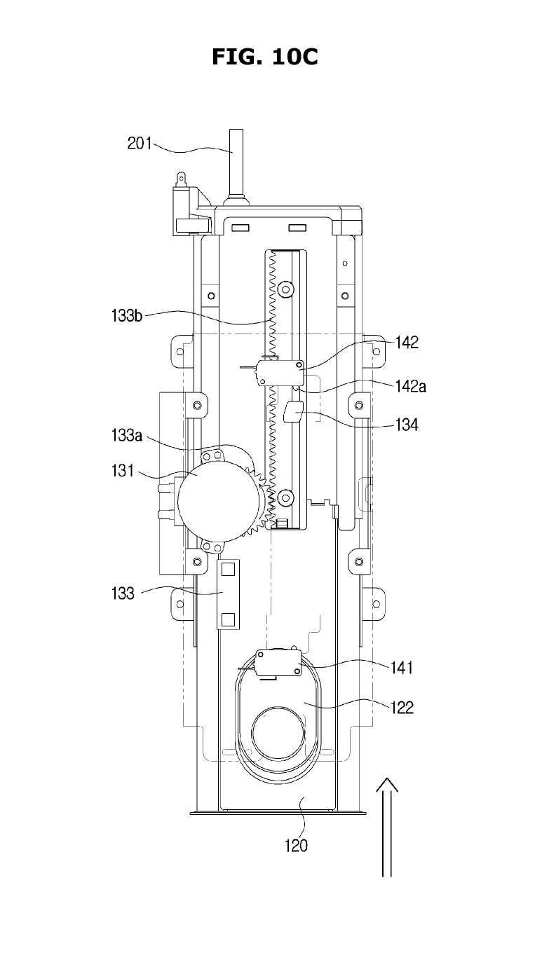

FIGS. 10A to 10C are views for describing an insertion or withdrawal operation of the water storage.

Referring to FIG. 10A, the water storage 120 is disposed behind the water supply device installation hole 14.

When water is stored in the water storage 120, the controller 300 operates the pump 210 and supplies water to the steam container 202 via the first connecting tube 201.

In a state in which the water storage 120 is inserted, the second detector 142a of the second switch 142 may be inserted into the second switch 142 due to the protrusion 134.

When the user touches the “reservoir” button 31a, the control panel 30 transmits an operation start command of the water storage 120 to the controller 300. The controller 300 determines whether the water storage 120 is inserted into the main body 10 as illustrated in FIG. 10A and operates the motor 131.

Referring to FIG. 10B, the motor 131 transmits a rotational force to the first gear unit 133a so that the water storage 120 is withdrawn toward the front of the main body 10.

According to the example, the first gear unit 133a rotates clockwise due to operation of the motor 131. The rack gear of the second gear unit 133b engaged with the pinion gear of the first gear unit 133a by the clockwise rotation operates the water storage 120 toward the front of the main body 10 in a direction indicated by an arrow in FIG. 10B.

During the withdrawal operation, the protrusion 134 may come into contact with the first detector 141a of the first switch 141. The first switch 141 transmits a signal indicating that the withdrawal operation is completed to the controller 300.

The controller 300 determines that the water reservoir 121 is protruded to an extent in which the inlet 122 of the water reservoir 121 may be exposed and stops supply of power to the motor 131.

After the water storage 120 is withdrawn, the user exposes the inlet 122 and supplies water to the water reservoir 121. Then, when the user touches the “reservoir” button 31a, the controller 300 operates the motor 131 again.

Referring to FIG. 100, the motor 131 according to the example provides a rotational force to the first gear unit 133a. Due to the rotational force, the first gear unit 133a rotates counterclockwise.

The rack gear of the second gear unit 133b engaged with the pinion gear of the first gear unit 133a by the counterclockwise rotation operates the water storage 120 toward the rear of the main body 10 in a direction indicated by an arrow in FIG. 100.

During the insertion operation, the protrusion 134 may come into contact with the second detector 142a of the second switch 142. The second switch 142 transmits a signal indicating that the insertion operation is completed to the controller 300.

The controller 300 determines that the water storage 120 is completely inserted into the main body 10 as illustrated in FIG. 10A and stops supply of power to the motor 131.

Then, the controller 300 outputs whether the insertion operation is completed to the user via the control panel 30. The controller 300 receives an input command from the user via the control panel 30, and an operation of the control panel 30 outputting an operational result will be described below with reference to FIGS. 11A and 11B.

FIGS. 11A and 11B are views for describing an operation of a control panel.

The control panel 30 including various buttons so that the user can control the operation of the cooking apparatus 1 may be disposed at the upper front portion of the main body 10.

As illustrated in FIG. 11A, the control panel 30 may include various buttons for receiving an input command from the user or hardware devices such as a switch, a pedal, a keyboard, a mouse, a track-ball, various levers, handles, and sticks.

A display 32 configured to display an operational state of the cooking apparatus 1 may be disposed on the display panel 30.

The display 32 of the control panel 30 according to the example may simultaneously serve as a touchscreen and an input device formed so that a predetermined command is performed when a body part or a special device touches a specific part of the screen. That is, the control panel 30 may include a graphical user interface (GUI) such as a touch pad, i.e., a software device, and the touch pad may be implemented with a touch screen panel (TSP) and form a mutual layer structure with the display 32.

The control panel 30 according to the example may include the display 32 configured to output design shapes, numbers, or the like and a button area 34 divided into quadrilateral sections to induce the user's touch.

As illustrated in FIG. 11A, the button area 34 may be formed in various shapes. In the button area 34, a touch panel that recognizes the user's touch may be embedded in a lower surface of the control panel 30, and the button area 34 may include a light emitting device configured to emit light when an input of the user is received.

The “reservoir” button 31a configured to control the motor 131 so that the water storage 120 is withdrawn from or inserted into the main body 10 may be provided at a lower right end of the button area 34. The “reservoir” button 31a according to the example may also be displayed by being divided into sections and receive an electrical signal due to the user's touch and transmit the electrical signal to the controller 300.

As illustrated in FIG. 11A, the “reservoir” button 31a may be designed to have a shape that embodies the water storage 120 and may be designed to have the shape of an arrow that embodies insertion or withdrawal.

The design of the “reservoir” button 31a is not necessarily limited to the above, and embodiments are not limited thereto.

The control panel 30 may include the display 32 configured to visually output an operational state of the cooking apparatus 1.

The display 32 may be provided as a cathode ray tube (CRT), a digital light processing (DLP) panel, a plasma display panel, a liquid crystal display (LCD) panel, an electro luminescence (EL) panel, an electrophoretic display (EPD) panel, an electrochromic display (ECD) panel, a light emitting diode (LED) panel, an organic LED (OLED) panel, or the like, but is not limited thereto.

Although not illustrated in FIG. 11A, in addition to visually outputting the operational state of the cooking apparatus 1, the control panel 30 may also aurally output the operational state of the cooking apparatus 1 using sound.

For example, when the water storage 120 is completely withdrawn, the control panel may output whether the water storage 120 is withdrawn to the user by using various sounds.

The control panel 30 outputs sound using a speaker (not illustrated) embedded in the cooking apparatus 1. An amplifier configured to convert an electrical signal into an acoustic signal and amplify the acoustic signal may be provided between the control panel 30 and the speaker.

Referring to FIG. 11B, the user touches the “reservoir” button 31a. When an electrical signal is generated due to touching the “reservoir” button 31a, the control panel 30 receives a command to insert or withdraw the water storage 120.

The control panel 30 transmits a signal to the controller 300, and the controller 300 operates the motor 131 to operate the water storage 120.

When the user touches the “reservoir” button 31a, the control panel 30 may cause light to be emitted from one of the arrow-shaped sections on the “reservoir” button 31a and output that an input command is received.

When a signal indicating that withdrawal of the water storage 120 is completed is transmitted on the basis of detection by the first switch 141, the control panel 30 may control the display 32 and output that the withdrawal operation is completed.

For example, the display 32 may output a message “Please add water” to transmit the signal indicating that the withdrawal operation is completed to the user.

After the withdrawal of the water storage 120 is completed, the control panel 30 may receive a touch input from the user again. According to the example, the user may touch the “reservoir” button 31a illustrated in FIG. 11B.

When the control panel 30 receives a touch input after a predetermined amount time elapses, the control panel 30 may transmit a signal to the controller 300 and control the water storage 120 to be inserted.

According to an example, the control panel 30 may cause light to be emitted from the other one of the arrow-shaped sections on the “reservoir” button 31a and output that an input command is received. The control panel 30 may change an output screen of the display 32 as illustrated in FIG. 11A or output a signal indicating that the water storage 120 is inserted to the user via other design outputs.

The UI operations described with reference to FIGS. 11A and 11B are merely examples of an operation of the cooking apparatus 1 disclosed herein, and embodiments are not limited thereto.

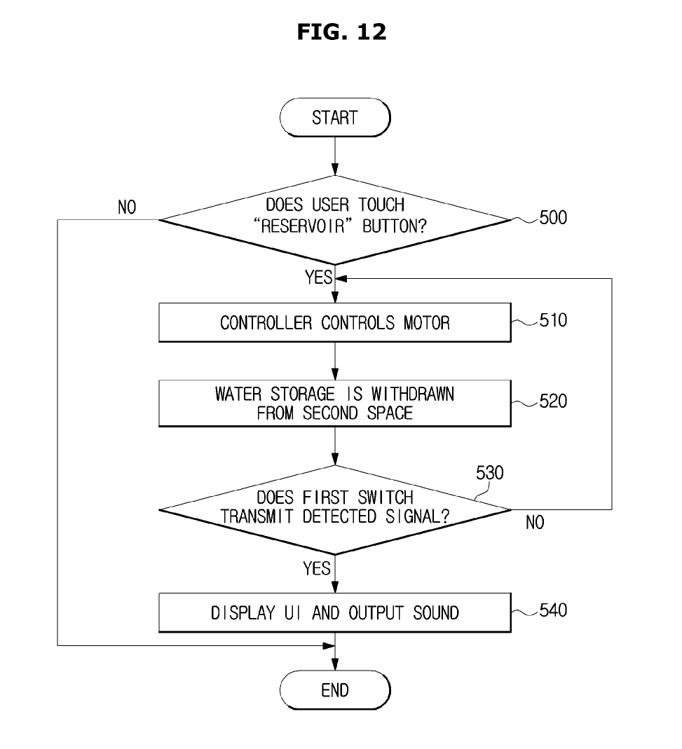

FIG. 12 is a flowchart for describing a control method related to the withdrawal operation of the water storage 120.

Referring to FIG. 12, the user may touch the “reservoir” button 31a of the control panel 30 and input a command to withdraw the water storage 120 (500).

The control panel 30 receives the withdrawal command and transmits the received command to the controller 300.

The controller 300 receives the withdrawal command from the user from the control panel 30 and operates the motor 131 (510).

The motor 131 receives power from a power supply and is operated by control of the controller 300.

The motor 131 according to the example may provide a clockwise rotational force so that the water storage 120 is withdrawn. However, the rotating direction is not necessarily limited to clockwise and may vary in accordance with positions and directions of the first gear unit 133a and the second gear unit 133b.

The water storage 120 is withdrawn toward the front of the main body 10 in the second space by the operation of the motor 131 (520).

By way of example, the clockwise rotational force generated due to rotation of the motor 131 is transmitted to the first gear unit 133a. The rotational force is converted into linear motion of the second gear unit 133b by the first gear unit 133a, and the second gear unit 133b operates so that the water storage 120 is withdrawn toward the front surface of the main body 10 from the upper portion of the main body 10 along the rail provided at the first fixing bracket 111a.

The first switch 141 transmits a detected signal to the controller (530).

When the water storage 120 is withdrawn by a predetermined distance, the first switch 141 may detect the withdrawal of the water storage 120. For example, when the protrusion 134 provided in the water storage 120 moves and applies pressure to the first detector 141a, the first switch 141 transmits a signal indicating that the water storage 120 is withdrawn by the predetermined distance to the controller 300.

When the first switch 141 does not transmit the signal indicating that the withdrawal is completed, the controller 300 continues to operate the motor 131 and controls the water storage 120 to be withdrawn.

When the first switch 141 detects completion of the withdrawal, the first switch 141 transmits a result of the detection to the controller 300, and the controller 300 controls the control panel 30 and outputs the fact that the withdrawal operation is completed to the user (540).

An outputting operation by the control panel 30 may be performed in various ways including the UI operations and sound outputs described above with reference to FIGS. 11A and 11B.

The water supply device 100 disclosed herein is provided in the second space, i.e., the machine room 21, in which components configured to control the internal environment of the cooking apparatus 1 are provided. Consequently, the water storage 120 may be provided in the machine room and withdrawn toward a front thereof by the operation of the motor 131. The user may conveniently supply water to the steam generator 200.

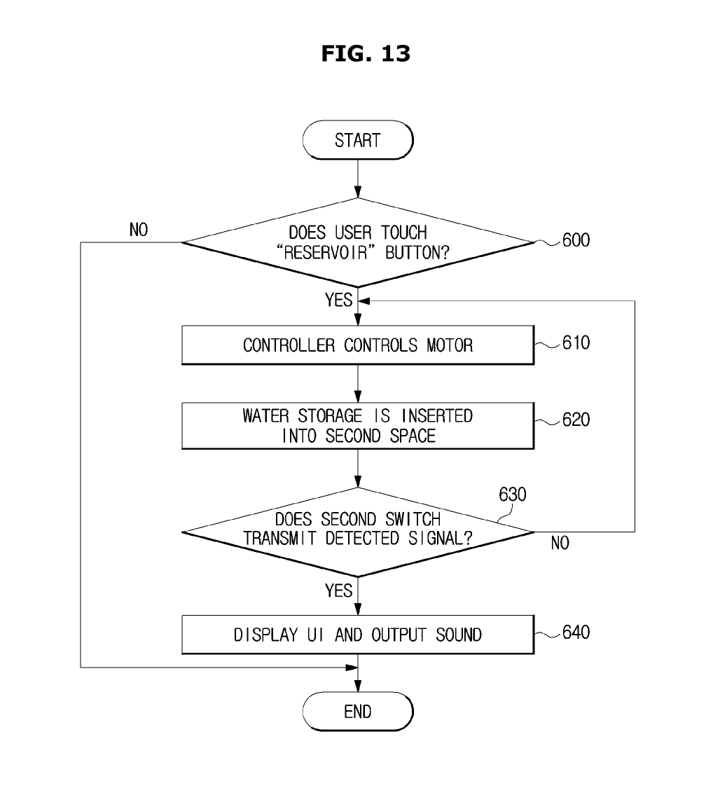

FIG. 13 is a flowchart for describing a control method related to the insertion operation of the water storage 120.

Referring to FIG. 13, the user may touch the “reservoir” button 31a of the control panel 30 again and input a command to insert the water storage 120 (600).

The control panel 30 receives the insertion command and transmits the received command to the controller 300.

The controller 300 receives the insertion command from the user from the control panel 30 and operates the motor 131 (610).

The motor 131 receives power from a power supply and is operated by control of the controller 300.

The motor 131 according to the example may provide a counterclockwise rotational force so that the water storage 120 is inserted into the main body 10. However, the rotating direction is not necessarily limited to counterclockwise and may vary in accordance with positions and directions of the first gear unit 133a and the second gear unit 133b.

The water storage 120 is inserted toward the rear of the main body 10 in the second space by the operation of the motor 131 (620).

By way of example, the counterclockwise rotational force generated due to rotation of the motor 131 is transmitted to the first gear unit 133a. The rotational force is converted into linear motion of the second gear unit 133b by the first gear unit 133a, and the second gear unit 133b operates so that the water storage 120 is inserted toward the rear surface of the main body 10 along the rail provided at the first fixing bracket 111a.

The second switch 142 transmits a detected signal to the controller (630).

When the water storage 120 is inserted by a predetermined distance, the second switch 142 may detect the insertion of the water storage 120. For example, when the protrusion 134 provided in the water storage 120 moves and applies pressure to the second detector 142a, the second switch 142 transmits a signal indicating that the water storage 120 is inserted by the predetermined distance to the controller 300.

When the second switch 142 does not transmit the signal indicating that the insertion is completed, the controller 300 continues to operate the motor 131 and controls the water storage 120 to be inserted.

When the second switch 142 detects completion of the insertion, the second switch 142 transmits a result of the detection to the controller 300, and the controller 300 controls the control panel 30 and outputs the fact that the insertion operation is completed to the user (640).

Using the above control method, the cooking apparatus 1 disclosed herein causes the water supply device to be automatically exposed or inserted just by a simple input command from the user. The user can conveniently supply water and does not have to manually operate the water reservoir 121 so that an accident such as spilling water in the water reservoir 121 is prevented.

As is apparent from the above description, in accordance with one embodiment of the present disclosure, a water supply device with an improved structure is provided at an outside of a cavity so that a cooking space can be secured in the cavity, a food capacity of the cavity can be increased, and cooking efficiency can be enhanced.

Further, a water supply device with an improved structure can automatically supply water by a control operation and prevent an accident in which water in a water reservoir is spilled due to exposure of the water supply device just by a control operation, thereby improving convenience and safety.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A cooking apparatus comprising:
a first compartment configured to perform a cooking operation;
a second compartment partitioned from the first compartment and having at least one component configured to control an internal environment of the first compartment;
a water supply device provided in the second compartment and configured to supply steam to the first compartment; and
a controller configured to control a movement of a portion of the water supply device so that the portion of the water supply device is inserted into or withdrawn from the second compartment.

2. The cooking apparatus of claim 1, wherein
the portion of the water supply device includes a water storage compartment configured to accommodate water, and
the water supply device further includes a driver configured to perform the movement of the water storage compartment, and
the controller is configured to control the driver to control the movement of the portion of the water supply device.

3. The cooking apparatus of claim 2, wherein
the water supply device includes at least one switch configured to detect the movement of the water storage compartment, and
the controller controls the driver based on detected signal provided by the at least one switch.

4. The cooking apparatus of claim 1, further comprising a control panel configured to receive an input command.

5. The cooking apparatus of claim 4, wherein the controller controls the movement of the portion of the water supply device based on the received input command.

6. A cooking apparatus comprising:
a first compartment configured to perform a cooking operation;
a second compartment partitioned from the first compartment and having at least one component configured to control an internal environment of the first compartment; and
a water supply device provided in the second compartment and configured to supply steam to the first compartment,
wherein a portion of the water supply device is configured to be inserted into or withdrawn from the second compartment.

7. The cooking apparatus of claim 6, wherein the second compartment is disposed above the first compartment in an installed position of the cooking apparatus.

8. The cooking apparatus of claim 6, further comprising a door configured to open and close, and thereby open and close the first compartment.

9. The cooking apparatus of claim 8, wherein, when the door closes the first compartment, the water supply device is covered by the door.

10. The cooking apparatus of claim 8, wherein, when the door opens the first compartment, the water supply device is exposed to a front of the cooking apparatus.

11. The cooking apparatus of claim 6, wherein the water supply device includes:
a housing provided inside the second compartment;
a water storage compartment configured to be inserted into or withdrawn from the housing, the portion of the water supply device including the water storage compartment; and
a driver configured to perform the movement of the water storage compartment.

12. The cooking apparatus of claim 11, wherein the water storage compartment includes:
a water reservoir having an inlet configured to receive water; and
a rubber cap detachably provided at the inlet of the water reservoir.

13. The cooking apparatus of claim 12, wherein the driver includes:
a motor; and
a gear member configured to connect the motor to the water storage compartment.

14. The cooking apparatus of claim 12, wherein the water supply device includes a steam generator connected to the water storage compartment.

15. The cooking apparatus of claim 13, wherein the driver further includes a switch provided to limit the withdrawal of the water reservoir.

16. The cooking apparatus of claim 14, wherein the water supply device includes a pump configured to transfer water from the water storage compartment to the steam generator.

17. A method comprising:
receiving, by a cooking apparatus having a first compartment configured to perform a cooking operation, and a second compartment partitioned from the first compartment, an input command; and
controlling, by the cooking apparatus and based on the input command, a movement of a portion of a water supply device provided in the second compartment such that the portion of a water supply device is inserted into or withdrawn from the second compartment.

18. The method of claim 17, wherein the water supply device includes:
a water storage compartment configured to accommodate water, the portion of the water supply device including the water storage compartment; and
a driver configured to perform the movement of the water storage compartment.

19. The method of claim 18, further comprising detecting, by a sensor of the cooking apparatus, the movement of the water storage compartment.

20. The method of claim 19, wherein the controlling further includes controlling an operation of the driver based on the detection of the movement of the water storage compartment.
